(19) United States
(12) Patent Application Publication
(10) Pub. No.: US 2026/0047543 A1
(43) Pub. Date: Feb. 19, 2026

(54) ANIMAL LITTER

(71) Applicant: Unicharm Corporation, Shikokuchuo-shi (JP)

(72) Inventors: Shinya Kaneko, Kanonji-shi (JP); Ruochen Zeng, Shanghai (CN); Zhangbin Su, Shanghai (CN); Lei Sun, Liaoning Province (CN); Wenfang Xu, Liaoning Province (CN)

(21) Appl. No.: 19/302,251

(22) Filed: Aug. 18, 2025

(30) Foreign Application Priority Data
Aug. 19, 2024 (CN) 202411139098.9

(51) Int. Cl. A01K 1/015; B01J 20/12; B01J 20/28

(52) U.S. Cl. CPC A01K 1/0154; B01J 20/12; B01J 20/28004; B01J 20/28011

(57) ABSTRACT

Provided is animal litter, wherein granular matters can adequately absorb urine, and wherein the granular matters can form small clumps having high strength at an early stage. Animal litter includes granular matters mainly composed of bentonite. The granular matters include 80% by mass or more of the granular matters having a grain size of 0.5 mm or more and 1.5 or less. Clump strength of a clump of the granular matters after 1 minute has elapsed since addition of 20 ml of a 0.9% by mass saline solution to the animal litter is 8.0 N or more.

### FIELD

The present invention relates to animal litter, and in particular, relates to animal litter mainly composed of bentonite.

### BACKGROUND

Animal litter used in animal (pet) litter boxes has been known. As animal litter, those comprising granular matters mainly composed of bentonite have been known. Granular matters mainly composed of bentonite absorb excreted urine, swell, and mutually adhere to form a clump. Granular matters that have been soiled by urine can be easily removed by removing the clump of the granular matters, and sanitary conditions of the animal litter can be satisfactorily maintained.

As animal litter, for example, PTL 1 discloses animal litter consisting of a plurality of granular matters mainly composed of bentonite. The granular matters of the animal litter include small-diameter granular matters having a grain size of 0.8 mm or more and less than 2 mm; and large-diameter granular matters having a grain size of 2 mm or more and less than 10 mm. The animal litter comprises the small-diameter granular matters in an amount in the range of 25% or more and 45% or less by weight relative to the large-diameter granular matters.

The animal litter, by comprising small-diameter granular matters, can inhibit excreted urine from excessively infiltrating in the depth direction to form a long clump of granular matters in the depth direction, and the urine from reaching the bottom portion of a litter box. The animal litter, by comprising large-diameter granular matters, can inhibit the granular matters from scattering as an animal scratches the animal litter with its foot.

### CITATION LIST

### Patent Literature

[PTL 1] Japanese Registered Patent Publication No. 6029333

### SUMMARY

### Technical Problem

Granular matters mainly composed of bentonite absorb excreted urine, swell, and mutually adhere to form a clump. However, a certain amount of time is needed for the clump having sufficient strength to form. If the granular matters are not sufficiently bound and lack sufficient strength, when an animal mischievously scratches the granular matters with its foot after excretion of urine, there is a risk that the clump disintegrate and become difficult to remove, or the disintegrated clump soils the litter box. It is desired that the urine be adequately absorbed by the granular matters, and that the granular matters form a clump having sufficient strength at an early stage.

The clump of granular matters is discarded externally by a user. In that case, if the size of the clump is small, the effort required for discarding the clump can be reduced. It is desired that the volume of an individual clump be decreased.

In particular, in recent years, the spread of automatic litter boxes for animals has been rapidly progressing in China. The problem as described above can still arise when using animal litter in an automatic litter box. In an automatic litter box, after a short time (example: 1 minute) has elapsed since an animal has excreted urine and exited the litter box, a clump of granular matters that has absorbed the urine is collected. Therefore, it is preferable that a clump of granular matters having sufficient strength can be formed at an early stage prior to collection, in order to facilitate collection of the clump. In addition, the collected clump is temporarily stored in a dust box, and the user then discards the clump in the dust box externally. Therefore, it is preferable that the volume of the clump can be decreased. so that the effort required for discarding the clump can be reduced.

Therefore, an object of the present invention is to provide animal litter, wherein granular matters can adequately absorb urine, and wherein the granular matters can form a small clump having high strength at an early stage.

### Solution to Problem

One aspect of the present invention is animal litter comprising granular matters mainly composed of bentonite, wherein the granular matters comprise 80% by mass or more of granular matters having a grain size of 0.5 mm or more and 1.5 mm or less, and wherein clump strength of a clump of the granular matters after 1 minute has elapsed since addition of 20 ml of a 0.9% by mass saline solution to the animal litter is 8.0 N or more.

### Advantageous Effects of Invention

According to the present invention, animal litter, wherein granular matters can adequately absorb urine, and wherein the granular matters can form a small clump having high strength at an early stage, can be provided.

### DESCRIPTION OF EMBODIMENTS

The present embodiment relates to the following aspects.

### Aspect 1

Animal litter comprising granular matters mainly composed of bentonite. wherein the granular matters comprise 80% by mass or more of granular matters having a grain size of 0.5 mm or more and 1.5 mm or less, and wherein clump strength of a clump of the granular matters after 1 minute has elapsed since addition of 20 ml of a 0.9% by mass saline solution to the animal litter is 8.0 N or more.

In the present animal litter, the granular matters comprise 80% by mass or more of granular matters having a grain size of 0.5 mm or more and 1.5 mm or less. Specifically, the present animal litter is composed of relatively small granular matters. Therefore, gaps between granular matters are narrow, and the specific surface area of individual granular matters is large. Mainly because the gaps between granular matters are narrow, a liquid such as urine can rapidly move via the gaps by capillary action, and is likely to be retained in the gaps. Mainly because the specific surface area of individual granular matters is large, the volume of the gaps in which a liquid can be retained is increased, and the volume that can contribute to absorption of the liquid in the granular matters is increased. Further, since the gaps between granular matters are narrow, when the granular matters absorb a liquid and swell, the granular matters can easily adhere together, and the area of such adhesion is increased. As a result, bonds between the granular matters are strengthened, and the clump has clump strength of 8.0 N or more after 1 minute has elapsed since the addition of 20 ml of a 0.9% by mass saline solution. Due to these synergistic effects, the present animal litter can quickly absorb a larger amount of liquid with a smaller amount of granular matters, and the granular matters that swell upon absorption of a liquid can quickly and firmly bind together. Therefore, when the present animal litter is densely layered in an animal litter box and a liquid such as urine is excreted, the granular matters can firmly bind into a clump that are shallow in the depth direction and small in the planar direction in a short amount of time. Specifically, it is possible for the granular matters to adequately absorb urine and for the granular matters to bind more firmly into a smaller clump more quickly. Even if an animal plays with the granular matters after excretion, the clump does not easily disintegrate, the walls and bottom portion of an animal litter box are not easily soiled. and the litter box is easily hygienically maintained. The effort required for discarding the clump can be reduced.

### Aspect 2

The animal litter according to Aspect 1, wherein the animal litter is used in an automatic litter box for cats.

In the present animal litter, granular matters firmly bind into a small clump in a short amount of time. Therefore, when the present animal litter is used in an automatic litter box for cats, in the case where the automatic litter box activates to collect excrement (a clump of granular matters) after a certain amount of time (example: 1 minute) since an animal has exited the litter box, the firm clump of granular matters can be formed at an early stage prior to collection. As a result, at the time of collection, the clump of granular matters does not easily disintegrate, the walls and bottom portion of the automatic litter box are not easily soiled, and the litter box is easily hygienically maintained. In addition, when collecting the clump of granular matters, the volume of the individual clump can be decreased. As a result, the effort required for discarding the clump can be reduced.

### Aspect 3

The animal litter according to Aspect 1 or 2, wherein a thickness of a clump of the granular matters when 20 ml of a 0.9% by mass saline solution is added to the animal litter is 40 mm or less.

In the present animal litter, the thickness (dimension in the depth direction) of a clump of granular matters when 20 ml of a 0.9% by mass saline solution is added can be limited to 40 mm or less. Therefore, when the present animal litter is densely layered in an animal litter box and urine is excreted. the granular matters can form a clump that is shallow in the depth direction. Specifically, it is possible for the granular matters to adequately absorb urine and for the granular matters to form a smaller clump. Since the clump is not excessively long in the depth direction, when removing the clump, disintegration from a deep portion of the clump can be inhibited. and the effort required for discarding the clump can be reduced.

### Aspect 4

The animal litter according to any one of Aspects 1 to 3. wherein volume of a clump of the granular matters after 1 minute has elapsed since addition of 20 ml of a 0.9% by mass saline solution to the animal litter is 20 ml/20 ml to 50 ml/20 ml.

In the present animal litter, the volume of a clump of granular matters after 1 minute has elapsed since the addition of 20 ml of a 0.9% by mass saline solution can be set to 20 ml/20 ml to 50 ml/20 ml. Therefore, when the present animal litter is densely layered in an animal litter box and urine is excreted, the volume of the clump of granular matters can be decreased. Specifically. it is possible for the granular matters to adequately absorb urine and for the granular matters to form a smaller clump. Since the clump is small, the clump during removal does not easily disintegrate, and since the clump has a certain size, the clump is easily separated from unsoiled litter and discarded.

### Aspect 5

The animal litter according to any one of Aspects 1 to 4, wherein cation-exchange capacity of the bentonite in the granular matters is 70 meq/100 g or more.

In the present animal litter, the cation-exchange capacity of bentonite in the granular matters is as high as 70 meq/100 g or more. Since the granular matters comprise a large amount of montmorillonite, bonds between granular matters that have absorbed a liquid can be strengthened. Therefore, when the present animal litter is densely layered in an animal litter box and urine is excreted, granular matters that have absorbed urine and swollen can be more firmly bound together. Specifically, it is possible for the granular matters to adequately absorb urine and for the granular matters to form a clump having higher strength.

### Aspect 6

The animal litter according to any one of Aspects 1 to 5, wherein pH of the bentonite in the granular matters is 9 to 11.

In the present animal litter, the pH. which is an indicator of Na (sodium) activation of bentonite in the granular matters. is as high as 9 to 11. Since the Na (sodium) ratio of the bentonite is high, the thickening property of the granular matters when a liquid is absorbed is increased. As a result, bonds between the granular matters that have absorbed a liquid can be strengthened. Therefore, when the present animal litter is densely layered in an animal litter box and urine is excreted, granular matters that have absorbed urine and swollen can be more firmly bound together. Specifically, it is possible for the granular matters to adequately absorb urine and for the granular matters to form a clump having higher strength.

### Aspect 7

The animal litter according to any one of Aspects 1 to 6, wherein a degree of swelling of the granular matters is 16 or greater.

In the present animal litter, the degree of swelling of the granular matters is as high as 16 or greater. Therefore, the granular matters easily absorb a larger amount of liquid. Thus, when the present animal litter is densely layered in an animal litter box and urine is excreted, a large amount of urine can be absorbed with a small amount of granular matters. Specifically, it is possible for the granular matters to adequately absorb urine and for the granular matters to form a small clump that is shallower in depth.

### Aspect 8

The animal litter according to any one of Aspects 1 to 7, further comprising a fragrance, wherein at least a portion of the fragrance is incorporated into an inner portion of each of the granular matters.

The present animal litter further comprises a fragrance, and at least a portion of the fragrance is incorporated into the inner portion of each of the granular matters (bentonite). Since the fragrance is gradually released from the inner portion of each of the granular matters, the scent of the fragrance can be maintained even when the present animal litter is used for a prolonged period. Therefore, urine odor released when the clump of granular matters that has absorbed urine is moved by an animal or user can be masked for a prolonged period. As a result, a sense of cleanliness can be felt continuously by a user for a prolonged period.

### Aspect 9

The animal litter according to any one of Aspects 1 to 8, further comprising an antibacterial agent.

The present animal litter further comprises an antibacterial agent. Therefore, the growth of bacteria due to a clump of granular matters that has absorbed urine or excrement of an animal can be inhibited. As a result, in the present animal litter, malodors are not easily generated, and a sense of cleanliness can be felt by a user.

### Aspect 10

The animal litter according to any one of Aspects 1 to 9, wherein clump strength of a clump of the granular matters after 5 minutes have elapsed since addition of 20 ml of a 0.9% by mass saline solution to the animal litter is identical to or greater than the clump strength of the clump of the granular matters after 1 minute has elapsed since the addition.

In the present animal litter, the clump strength of a clump of granular matters after 5 minutes have elapsed since the addition of 20 ml of a 0.9% by mass saline solution is equivalent to or greater than the clump strength of the clump of the granular matters after 1 minute has elapsed since the addition. In other words, the strength of clump does not decrease even after 1 minute or 5 minutes since the addition of a saline solution. Therefore, when the present animal litter is densely layered in an animal litter box and urine is excreted, if a clump of granular matters having high strength are formed after 1 minute, the clump of granular matters can maintain high strength even after 5 minutes have elapsed. Since the clump of granular matters can maintain high strength over time, even when a certain amount has accumulated and then discarded externally, the clump does not easily disintegrate and is easily discarded.

### Aspect 11

The animal litter according to any one of Aspects 1 to 10. wherein the clump strength of the clump of the granular matters after 1 minute has elapsed since addition of 20 ml of a 0.9% by mass saline solution to the animal litter is 80% or more of clump strength of the clump of the granular matters after 5 minutes have elapsed since the addition.

In the present animal litter, the clump strength of the clump of granular matters after 1 minute has elapsed since the addition of 20 ml of a 0.9% by mass saline solution is 80% or more of the clump strength of the clump of the granular matters after 5 minutes have elapsed since the addition. In other words, the strength of the clump, after just 1 minute has elapsed since the addition of a saline solution, reaches a sufficiently high value. Therefore, when the present animal litter is densely layered in an animal litter box and urine is excreted. after just 1 minute has elapsed, a clump of granular matters having sufficiently high strength can be formed. Since the clump of granular matters is formed so as to have high strength in a short amount of time, the clump does not easily disintegrate and are easy to handle even when moved immediately after clump formation and discarded.

### Aspect 12

The animal litter according to any one of Aspects 1 to 11, wherein powder content of the animal litter is 0.50% by mass or less.

In the animal litter, the powder content is 0.50% by mass or less. Therefore, powder generation of the animal litter is small. powder is less likely to scatter in a litter box or around the litter box. facilitating cleaning of the litter box and the surroundings of the litter box. In addition, since powder generation is small, the likelihood of damaging electronic devices such as automatic litter boxes can be decreased.

Hereinafter. the animal litter according to the present embodiment will be described.

The animal litter according to the present embodiment is animal litter comprising granular matters mainly composed of bentonite, wherein the granular matters comprise 80% by mass or more of granular matters having a grain size of 0.5 mm or more and 1.5 mm or less, and wherein clump strength of a clump of the granular matters after 1 minute has elapsed since the addition of 20 ml of a 0.9% by mass saline solution to the animal litter is 8.0 N or more. Hereinafter, the embodiment will be described in detail.

The present animal litter comprises granular matters mainly composed of bentonite. “Mainly composed of” means having a component in a ratio exceeding 50% by mass among all constituent components. The ratio of bentonite in the granular matters is preferably 70% by mass or more, more preferably 80% by mass or more, and even more preferably 90% by mass or more. When the ratio of bentonite is high, excreted urine can be more reliably absorbed, and excessive infiltration in the depth direction can be inhibited.

The granular matters are not particularly limited as long as the main component is bentonite, and granular matters in any form can be adopted. Examples of such granular matters include granular matters obtained by pulverizing raw bentonite ore with a Raymond mill and then rounding the corners, granular matters obtained by granulating a mixture of mainly finely crushed raw bentonite ore and another material, and granular matters obtained by further pulverizing the granulated mixture (granulated product).

The present animal litter, in addition to the granular matters mainly composed of bentonite, may comprise another material. Examples of other materials include inorganic materials such as zeolite and silica gel; various additives such as fragrances, antibacterial agents, and coloring agents; and clumping accelerators such as sodium carbonate. Such other materials may be contained in the granular matters mainly composed of bentonite, or may be separate (example: separate granular matters) from the granular matters mainly composed of bentonite. The ratio of other materials in the animal litter, from the viewpoint of suitably maintaining viscosity of the granular matters after absorbing urine, is preferably 10% by mass or less, more preferably 5% by mass or less, and even more preferably 3% by mass or less.

In the present animal litter, the granular matters comprise 80% by mass or more of granular matters having a grain size of 0.5 mm or more and 1.5 mm or less. When the grain size of 80% by mass or more of the granular matters is 0.5 mm or more, powder generation of the animal litter can be suppressed, and scattering of the granular matters as an animal scratches the animal litter with its foot can be inhibited. When the grain size of 80% by mass or more of the granular matters is 1.5 mm or less, gaps between granular matters can be narrowed, and the specific surfaced area of individual granular matters can be increased. The granular matters of the animal litter preferably comprise 84% by mass or more of granular matters having a grain size of 0.5 mm or more and 1.5 mm or less, and more preferably comprise 88% by mass or more thereof.

In the present animal litter. among the granular matters having a grain size of 0.5 mm or more and 1.5 mm or less, the mass ratio of granular matters having a grain size in the range of 1.0 to 1.5 mm to granular matters having a grain size in the range of 0.5 to 1.0 mm is not particularly limited. The mass ratio ((granular matters having a grain size in the range of 1.0 to 1.5 mm)/(granular matters having a grain size in the range of 0.5 to 1.0 mm)) includes, for example, 1.0 to 2.0, and is preferably 1.1 to 1.9, from the viewpoint of a balance between suppressing the above powder generation and scattering (large grain size) and narrowing gaps to increase specific surface area (small grain size).

In the present animal litter. the shape of the granular matters is not particularly limited. Examples of shapes thereof include a crushed shape, a substantially spherical shape, a substantially cylindrical shape, and a substantially polygonal columnar shape. A crushed shape refers to a shape of granular matters obtained by pulverizing a granulated product of raw bentonite ore or a finely pulverized product thereof, or a shape obtained by rounding the comers of the pulverized granular matters. In the present embodiment, the shape is a crushed shape (corners rounded).

In the present animal litter, the clump strength of a clump of granular matters after 1 minute has elapsed since the addition of 20 ml of a 0.9% by mass saline solution to the animal litter is 8.0 N or more. When the clump strength is 8.0 N or more, a clump does not easily disintegrate even when an animal plays with the granular matters after excretion, and thus the walls and bottom portion of an animal litter box are not easily soiled, and a sanitary environment of the animal litter box is easily maintained. Since the clump does not easily disintegrate during disposal treatment, the clump can be easily discarded. The clump strength is preferably 9.0 N or more, and more preferably 10.0 N or more.

### Measurement Method for Grain Size Distribution (Grain Size) of Granular Matters

The grain size distribution of the granular matters is measured by the following sieving method.

In a sieving method, the size range of granular matters is determined by the mesh openings of a sieve. The grain size distribution of the granular matters can be obtained by sieving granular matters having a predetermined mass (example: 150 g) for a predetermined amount of time (example: 3 minutes), using a vibratory sieve machine (example: “AS-200” manufactured by Retsch GmbH) comprising a plurality of sieves having different mesh openings, and calculating the mass percentage (%) based on the mass (g) of the granular matters remaining on each sieve. As the above plurality of sieves having different mesh openings, for example, a plurality of sieves having mesh openings of 0.15 mm, 0.3 mm, 0.5 mm, 1.0 mm, 1.5 mm, 2.0 mm, and 2.5 mm, respectively, can be used. Therefore. for example, granular matters having a grain size of 0.5 mm or more and 1.5 mm or less refer to granular matters that pass through a sieve having mesh openings of 1.5 mm and do not pass through a sieve having mesh openings of 0.5 mm.

### Measurement Method for Clump Strength of Clump of Granular Matters and Mass and Thickness of Clump

The clump strength and thickness of a clump of the granular matters are measured by the following method.
(1) Granular matters are added into a container so as to have a depth of 10 cm or more.
(2) 20 ml of a 0.9% by mass saline solution is set up in a separatory funnel: capacity of 100 ml (manufactured by Sibata Scientific Technology Ltd.). The predetermined first apparatus is an apparatus for dropping the saline solution onto surfaces of the granular matters within the container, and the dropping rate of the saline solution is preadjusted to be 20 ml/10 seconds.
(3) The saline solution is dropped onto the surfaces of the granular matters within the container.
(4) After dropping is complete and a predetermined amount of time (example: 1 minute, 3 minutes, or 5 minutes) has elapsed, all of the granular matters in the container are placed on a tray, and a clump of the granular matters is removed therefrom.
(5) The dimension (thickness) (mm) in the depth direction (vertical direction) of the clump and the mass (g) of the clump are measured. Thickness is measured as the distance between the uppermost portion and the lowermost portion of the clump in the vertical direction.
(6) The clump is set up on a horizontal surface, which is the upper surface of a plastic box. The clump is set up so that the surfaces of the granular matters where the saline solution has been dropped (upper surface of clump) face downward.
(7) A 12-mm diameter terminal attached to a digital force gauge (FGP-5 manufactured by Nippon Densan Shinpo Co., Ltd.) is pressed vertically from above into the upper surface of the clump at a speed of 400 mm/minute to apply a load to (the upper surface of) the clump.
(8) The maximum value of the load measured until the terminal reaches the horizontal surface is read to obtain a clump strength (N) of the clump of granular matters.

As described above, in the present animal litter, the granular matters comprise 80% by mass or more of granular matters having a grain size of 0.5 mm or more and 1.5 mm or less. Specifically, the present animal litter is composed of relatively small granular matters. Therefore, compared to conventional animal litter, gaps between granular matters are narrow, and the specific surface area of individual granular matters is increased. Mainly because the gaps between granular matters are narrow, a liquid such as urine can rapidly move via the gaps by capillary action, does not easily outflow from the gaps, and is likely to be retained in the gaps. Mainly because the specific surface area of individual granular matters is large, the volume of the gaps in which a liquid can be retained is increased, and the volume that can contribute to absorption of the liquid in the granular matters is increased. Further, since the gaps between granular matters are narrow, when the granular matters absorb a liquid and swell, the granular matters can easily adhere together, and the area of the adhesion is increased. As a result, bonds between the granular matters are strengthened, and the clump have a clump strength of 8.0 N or more after 1 minute has elapsed since the addition of 20 ml of a 0.9% by mass saline solution. Due to these synergistic effects, the present animal litter can quickly absorb a larger amount of liquid with a smaller amount of granular matters, and the granular matters that swell upon absorption of a liquid can quickly and firmly bind together. Therefore, when the present animal litter is densely layered in an animal litter box and a liquid such as urine is excreted, the granular matters can firmly bind into a clump that are shallow in the depth direction and small in the planar direction in a short amount of time. Specifically, it is possible for the granular matters to adequately absorb urine and for the granular matters to bind more firmly into a smaller clump more quickly Even if an animal plays with the granular matters after excretion, the clumps do not easily disintegrate, the walls and bottom portion of an animal litter box are not easily soiled, and the litter box is easily hygienically maintained. The effort required for discarding the clump can be reduced.

In a preferable aspect of the present embodiment, the animal litter is used in an automatic litter box for cats. In the automatic litter box for cats. after a short time (example: 1 minute) has elapsed since a cat excretes urine onto the litter and exits the litter box, clumps of granular matters that have formed by absorbing the urine are automatically collected from the litter. For example, the clumps are separated from the animal litter and stored in a dedicated litter box.

In the present animal litter, granular matters firmly bind into small clumps in a short amount of time. Therefore, when the present animal litter is used in an automatic litter box for cats, in the case where the automatic litter box activates to collect excrement (clumps of granular matters) after a certain amount of time (example: 1 minute) since an animal has exited the litter box, firm clumps of granular matters can be formed at an early stage prior to collection. As a result, at the time of collection, clumps of granular matters do not easily disintegrate. the walls and bottom portion of the automatic litter box are not easily soiled. and the litter box is easily hygienically maintained. In addition, when collecting the clumps of granular matters, the volume of individual clumps can be decreased. As a result, the effort required for discarding the clumps can be reduced. The automatic litter box does not necessarily have to be for use for cats, and may be for use for other animals.

In a preferable aspect of the present embodiment. the thickness (depth) of a clump of granular matters when 20 ml of a 0.9% by mass saline solution is added to the animal litter is 40 mm or less. When the thickness of a clump is 40 mm or less, the clump is not excessively long (excessively large) in the depth direction, and a deep portion of the clump does not easily crack. The thickness of the clump is more preferably 36 mm or less. The lower limit of the thickness of a clump of granular matters is not particularly limited, but is preferably 5 mm or more, and more preferably 8 mm or more. When the thickness of a clump is 5 mm or more, the clump is not excessively thin and can be inhibited from cracking.

The thickness of a clump of granular matters is as described in the above <Measurement method for clump strength of clump of granular matters and mass and thickness of clump>.

In the present animal litter, the thickness (dimension in the depth direction) of a clump of granular matters when 20 ml of a 0.9% by mass saline solution is added can be limited to 40 mm or less. Therefore, when the present animal litter is densely layered in an animal litter box and urine is excreted, the granular matters can form clumps that are shallow in the depth direction. Specifically, it is possible for the granular matters to adequately absorb urine and for the granular matters to form smaller clumps. Since the clumps are not excessively long in the depth direction, when removing the clumps, disintegration from deep portions of the clumps can be inhibited, and the effort required for discarding the clumps can be reduced.

In a preferable aspect of the present embodiment. the volume of a clump of granular matters after 1 minute has elapsed since the addition of 20 ml of a 0.9% by mass saline solution to the animal litter is 20 ml/20 ml to 50 ml/20 ml. The unit “/20 ml” means “per 20 ml of saline solution to be absorbed”. Therefore. “volume of a clump” in this case is the volume of a clump formed after 1 minute when 20 ml of a saline solution is absorbed by the animal litter. When the volume of a clump is 20 ml/20 ml or more, the clump is not excessively small, and easily separates from granular matters that have not absorbed saline solution. When the volume of a clump is 50 ml/20 ml or less, the clump is not excessively large, and the clump is easily discarded. The volume of a clump is preferably 25 ml/20 ml to 45 ml/20 ml.

### Measurement Method for Volume of Clump of Granular Matters

The volume of a clump of the granular matters is measured by the following method.
(1) The (1) to (5) in <Measurement method for clump strength of clump of granular matters and mass and thickness of clump> are carried out.
(2) Volume of the clump is calculated by the following formula.

$$Volume ( ml ) of clump = ( mass ( g ) of clump - 20 ( mass of saline solution \text{:} g ) ) / bulk density ( g / ml )$$

For bulk density, a value obtained by dividing the total mass (g) of the granular matters, before absorbing a saline solution, when the granular matters are filled level to the top of a predetermined container having a fixed volume (example: 1000 ml (1 L)) by the volume of the predetermined container is used.

In the present animal litter, the volume of clumps of granular matters after 1 minute has elapsed since the addition of 20 ml of a 0.9% by mass saline solution can be set to 20 ml/20 ml to 50 ml/20 ml. Therefore, when the present animal litter is densely layered in an animal litter box and urine is excreted, the volume of the clumps of granular matters can be decreased. Specifically, it is possible for the granular matters to adequately absorb urine and for the granular matters to form smaller clumps. Since the clumps are small, the clumps during removal do not easily disintegrate, and since the clumps have a certain size, the clumps are easily separated from unsoiled litter and discarded.

In a preferable aspect of the present embodiment, the lengths of a long side and a short side of a clump of granular matters when 20 ml of a 0.9% by mass saline solution is added to the animal litter are 60 mm or less. The long side and short side of the clump are lengths of the long side and short side of a rectangle that can enclose a projection of the clump onto a plane perpendicular to the depth direction with the smallest area. By setting the lengths of the long side and short side of the clump to 60 mm or less, the clump is not excessively large in the planar direction perpendicular to the depth direction, and end portions of the clump in the planar direction do not easily crack. The short side of the clump is more preferably 55 mm or less.

In a preferable aspect of the present embodiment, the cation-exchange capacity of bentonite in the granular matters is 70 meq/100 g or more. The unit “/100 g” means “per 100 g of granular matters”. Therefore, “cation-exchange capacity of bentonite in the granular matters” in this case is the cation-exchange capacity per 100 g of granular matters. When the cation-exchange capacity is 70 meq/100 g or more, the granular matters can be said to comprise a large amount of montmorillonite. As a result, the swelling property due to absorption of a liquid and the thickening property of the granular matters can be increased. The cation-exchange capacity is more preferably 75 meq/100 g or more. The upper limit of the cation-exchange capacity is not particularly limited and includes, for example, 100 meq/100 g.

### Measurement Method for Cation-Exchange Capacity of Bentonite

The cation-exchange capacity of bentonite in the granular matters is measured by the following method.

The cation-exchange capacity is measured as a saturated absorption amount (unit: g) of methylene blue by 100 g of bentonite in water.

### (1) Apparatus

Class A burette, conforming to requirements of GB/T 12805
Magnetic stirrer
Electronic balance. sensitivity of 0.001 g

### (2) Reagent

Sodium pyrophosphate solution, analytical grade of 1% by mass
Methylene blue solution (0.002 g/ml): 2.000 g of methylene blue (methylene blue trihydrate, relative molecular mass of 373.9) is accurately weighed, dissolved in distilled water, diluted to the indicator line with running water in a 1000-ml volumetric flask, mixed well until homogeneous, and stored in a brown glass bottle.

### (3) Procedure

(i) 2.000±0.001 g of a dried bentonite sample is added into a 250-ml Erlenmeyer flask and moistened by adding 50 ml of distilled water. 20 ml of 1% sodium pyrophosphate solution is added and shaken well, then heated to boiling with an electric heater for 5 minutes, and cooled to room temperature in air.
(ii) The methylene blue solution is dropped into the sample solution using the burette. During titration, initially about ⅔ of the expected amount is added, and the mixture is shaken and allowed to react completely for 1 minute. Thereafter, 1-ml to 2-ml portions are dropped each time, followed by shaking for 30 seconds. A glass rod is then dipped into the test solution to transfer a drop thereof onto medium-speed quantitative filter paper. Observation is made on whether a light blue halo appears around a dark blue spot on the filter paper. If not, dropping of the methylene blue solution continues.
(iii) If a light blue halo starts to appear, shaking of the test solution continues for 2 minutes, then using a glass rod, a drop of the test solution is transferred onto medium-speed quantitative filter paper, and observation is made on whether a light blue halo appears. The case where a light blue halo does not appear means that an end point has not been reached, and dropping of the methylene blue solution continues (0.5 ml to 1 ml each time).
(iv) The case where a clear light blue halo (halo width is 0.5 mm to 1 mm) after shaking for 2 minutes indicates that the end point of the test has been reached, and the determined volume is recorded.

### (4) Calculation

$$MB = c \cdot V / m \times 100$$

MB: absorption amount. unit is per 100 g (g/100 g)
c: concentration (g/ml) of methylene blue solution
V: titration amount (ml) of methylene blue solution
m: mass (g) of sample
100: factor to convert the absorption capacity of 1 gram of bentonite to absorption capacity of 100 g of bentonite

In the present animal litter, the cation-exchange capacity of bentonite in the granular matters is as high as 70 meq/100 g or more. Since the granular matters comprise a large amount of montmorillonite, bonds between granular matters that have absorbed a liquid can be strengthened. Therefore, when the present animal litter is densely layered in an animal litter box and urine is excreted, granular matters that have absorbed urine and swollen can be more firmly bound together. Specifically, it is possible for the granular matters to adequately absorb urine and for the granular matters to form clumps having higher strength.

In a preferable aspect of the present embodiment, the pH of bentonite in the granular matters is 9 to 11. When the pH is as high as 9 to 11, the bentonite in the granular matters can be said to comprise a large number of Na⁺(sodium ions). As a result, the granular matters have high swelling property and high thickening property. The pH of bentonite in the granular matters is preferably 9.5 to 10.5.

### Measurement Method for pH Level of Bentonite

The pH of bentonite in the granular matters is measured by the following method.

The pH of bentonite is measured as the pH value of a solution or suspension.

### (1) Apparatus

pH meter
Graduated cylinder—100 ml
Glass beaker—250 ml
Electronic balance

### (2) Reagent

Standard buffer solution
Distilled water or deionized water

### (3) Procedure

The pH meter is adjusted by the following method:
(i) The pH meter is switched on, and preheated for 30 minutes.
(ii) The pH meter is calibrated with the buffer solution
(iii) 6.25 g of the sample is weighed out, slowly added into the beaker containing 100 ml of distilled water, and stirred for 5 minutes.
(iv) The pH of the suspension is measured until the measured value is constant. (Measurement of pH is carried out at room temperature.)

In the present animal litter, the pH, which is an indicator of Na (sodium) activation of bentonite in the granular matters, is as high as 9 to 11. Since the Na (sodium) ratio of the bentonite is high, the thickening property of the granular matters when a liquid is absorbed is increased. As a result, bonds between the granular matters that have absorbed a liquid can be strengthened. Therefore, when the present animal litter is densely layered in an animal litter box and urine is excreted, granular matters that have absorbed urine and swollen can be more firmly bound together. Specifically, it is possible for the granular matters to adequately absorb urine and for the granular matters to form clumps having higher strength.

In a preferable aspect of the present embodiment, the degree of swelling of granular matters is 16 or greater. As such, in the present animal litter, since the degree of swelling of granular matters is as high as 16 or greater, the granular matters absorb a larger amount of liquid more easily. Therefore, when the present animal litter is densely layered in an animal litter box and urine is excreted, a large amount of urine can be absorbed with a small amount of granular matters. Specifically, it is possible for the granular matters to adequately absorb urine and for the granular matters to form small clumps that are shallower in depth.

### Measurement Method for Degree of Swelling of Granular Matters

The degree of swelling of the granular matters is measured by the following method.

The degree of swelling of the granular matters is measured by the expansion of volume when bentonite absorbs water.

### (1) Apparatus

Electronic balance
100—ml graduated cylinder

### (2) Reagent

Distilled water
Bentonite sample for testing

### (3) Procedure

(i) 2.0 g of the sample is weighed (bentonite having a moisture content of 8 to 12%)
(ii) The 100-ml graduated cylinder is filled with distilled water up to the 100-ml mark.
(iii) A small amount of bentonite is added to the water surface from the upper portion of the graduated cylinder.

Note: The amount added each time is 50 to 100 mg, and the addition rate is 6 to 10 minutes each time.
(iv) Waiting until the bentonite is completely immersed, the previous procedure is repeated until all of the bentonite is expended.
(v) When about 1 g of the sample has been added, if the surface of the swollen substance is uneven, the graduated cylinder is rotated 180 degrees, and the addition continues.
(vi) After leaving to stand for 24 hours. the apparent volume of the completely swollen bentonite is measured. This value is the self-swelling volume (degree of swelling).

In a preferable aspect of the present embodiment. the moisture content of the granular matters is 1 to 20% by mass. The moisture content of the granular matters is preferably 2 to 15% by mass, and more preferably 3 to 12% by mass. Since the moisture content of the granular matters is as low as 20% by mass or less, the granular matters absorb a larger amount of liquid more easily. When the moisture content of the granular matters is 1% by mass or more, powder generation (dust generation) does not easily occur. Therefore, when the present animal litter is densely layered in an animal litter box, powder generation can be suppressed, and when urine is excreted, a large amount of urine can be absorbed with a small amount of granular matters. Specifically, it is possible for the granular matters to adequately absorb urine and for the granular matters to form small clumps that are shallower in depth.

### Measurement Method for Moisture Content of Granular Matters

The moisture content of the granular matters is measured by the following method.

The moisture content of the granular matters is measured based on weight loss due to evaporation of moisture. When the sample is heated to the boiling point (100° C.) of water, free water (i.e., non-chemically bound water) adsorbed onto the material evaporates. The weight lost is then evaluated, and the moisture of the material is calculated.

### (1) Apparatus

Electronic balance
Oven/Mettler moisture analyzer
Desiccator

### (2) Reagent

Sample

### (3) Procedure

(i) Oven test method
   (i-1) Temperature of the oven is maintained at 105° C.
   (i-2) 10.0 g of the sample is weighed out, and placed in the oven for at least 3 hours to be dried.
   (i-3) The dried sample is cooled to room temperature in a dryer, and then weighed out.

$$Moisture ( \% ) = \{ ( mass before drying - mass after drying ) / ( mass before drying ) \} \times 1000.$$

(ii) Moisture analyzer test
   (ii-1) Heating temperature of the moisture analyzer is set to 105° C.
   (ii-2) For non-homogeneous substances, approximately 10 g of the sample is weighed out. For homogeneous powdered substances, 7 to 8 g is weighed out and arranged within the moisture analyzer.
   (ii-3) When operation of the moisture analyzer stops, moisture content of the sample is automatically displayed.

In a preferable aspect of the present embodiment, the animal litter further comprises a fragrance. At least a portion of the fragrance is incorporated into the inner portions of the granular matters. Specifically, in the animal litter, a fragrance is contained in the granular matters. For example, the fragrance may be incorporated between adjacent montmorillonite unit layers within the bentonite. The fragrance can be released in small amounts from between the unit layers.

The fragrance is not particularly limited, and examples include alcohols such as geraniol, citronellol, citral, eugenol, phenethyl alcohol, thymol, linalool, leaf alcohol. menthol, and benzyl alcohol; and aldehydes such as hexyl cinnamaldehyde. These fragrances can suppress the odor of excreted urine and feces. The fragrance, for example, is sprayed onto the granular matters alone or by dissolving in an organic solvent such as ethanol. and is thereby adsorbed and contained in the granular matters.

The present animal litter further comprises a fragrance, and at least a portion of the fragrance is incorporated into the inner portions of the granular matters (bentonite). Since the fragrance is gradually released from the inner portions of the granular matters, the scent of the fragrance can be maintained even when the present animal litter is used for a prolonged period. Therefore, urine odor released when the clumps of granular matters that have absorbed urine are moved by an animal or user can be masked for a prolonged period. As a result, a sense of cleanliness can be felt continuously by a user for a prolonged period.

In a preferable aspect of the present embodiment. the animal litter further comprises an antibacterial agent. The antibacterial agent may be separate from the granular matters (bentonite), may be present on the surfaces of the granular matters, or may be incorporated into the inner portions of the granular matters. For example, the antibacterial agent, if incorporated between adjacent montmorillonite unit layers within the bentonite, can be released in small amounts from between the unit layers, and the effect can be prolonged. If the antibacterial agent is mixed into the animal litter alone or by being supported on a carrier such as zeolite, the amount of antibacterial agent in the animal litter can be easily adjusted.

The antibacterial agent is not particularly limited and includes, for example, organic, inorganic metal-based, photocatalyst-based, and natural antibacterial agents. The antibacterial agent includes, for example, cationic antibacterial agents. Other examples include isothiazolinone antibacterial agents. Examples of cationic antibacterial agents include guanidine antibacterial agents, biguanide antibacterial agents, and quatemary ammonium salts. Examples of guanidine antibacterial agents include polyhexamethylene guanidine (PHMG). Examples of biguanide antibacterial agents include polyhexamethylene biguanide (PHMB), also known as polyaminopropyl biguanide. Examples of quaternary ammonium salts include benzalkonium chloride and benzethonium chloride. Examples of isothiazolinone antibacterial agents include methylisothiazolinone, methylchloroisothiazolinone, and octylisothiazolinone. These antibacterial agents may be used alone as one type, or may be used in combination of a plurality of types. By using these antibacterial agents, the growth of bacteria can be inhibited. The antibacterial agent, for example, is sprayed onto the granular matters alone or by dissolving in an organic solvent such as ethanol, and is thereby adsorbed onto the granular matters. Alternatively, the antibacterial agent, for example, is sprayed onto separate granular matters of zeolite or silica gel alone or by dissolving in an organic solvent such as ethanol, and is thereby adsorbed onto the separate granular matters. The separate granular matters are added in a predetermined amount to the granular matters of bentonite. The preferable antibacterial agent is a mixture comprising methylisothiazolinone, methylchloroisothiazolinone, 2-bromo-2-nitropropane-1,3-diol, and benzalkonium chloride.

The present animal litter further comprises an antibacterial agent, and thus the growth of bacteria due to clumps of granular matters that have absorbed urine or excrement of an animal can be inhibited. As a result, in the present animal litter, malodors are not easily generated, and a sense of cleanliness can be felt by a user.

In a preferable aspect of the present embodiment, the clump strength of clumps of granular matters after 5 minutes have elapsed since the addition of 20 ml of a 0.9% by mass saline solution to the animal litter is identical to or greater than the clump strength of the clumps of the granular matters after 1 minute has elapsed since the addition. The measurement method for clump strength of clumps after 5 minutes and 1 minute since the addition of a saline solution is as described in the above <Measurement method for clump strength of clump of granular matters and mass and thickness of clump>.

In the present animal litter. the clump strength of clumps of granular matters after 5 minutes have elapsed since the addition of a saline solution is equivalent to or greater than the clump strength of the clumps of the granular matters after 1 minute has elapsed since the addition. In other words, the strength of clumps does not decrease even after 1 minute or 5 minutes since the addition of a saline solution. Therefore, when the present animal litter is densely layered in an animal litter box and urine is excreted, if clumps of granular matters having high strength are formed after 1 minute, the clumps of granular matters can maintain high strength even after 5 minutes have elapsed. Since the clumps of granular matters can maintain high strength over time, when a certain amount has accumulated and then discarded externally, the clumps do not easily disintegrate and are easily discarded.

In a preferable aspect of the present embodiment, the clump strength of clumps of granular matters after 1 minute has elapsed since the addition of 20 ml of a 0.9% by mass saline solution to the animal litter is 80% or more of the clump strength of the clumps of the granular matters after 5 minutes have elapsed since the addition. The clump strength after 1 minute has elapsed is preferably 85% or more of the clump strength after 5 minutes have elapsed. The measurement method for clump strength of clumps after 5 minutes and 1 minute since the addition of a saline solution is as described in the above <Measurement method for clump strength of clump of granular matters and mass and thickness of clump>.

In the present animal litter, the clump strength of clumps of granular matters after 1 minute has elapsed since the addition of 20 ml of a 0.9% by mass saline solution is 80% or more of the clump strength of the clumps of the granular matters after 5 minutes have elapsed since the addition. In other words, the strength of the clumps, after just 1 minute has elapsed since the addition of a saline solution, reaches a sufficiently high value. Therefore, when the present animal litter is densely layered in an animal litter box and urine is excreted, after just 1 minute has elapsed, clumps of granular matters having sufficiently high strength can be formed. Since the clumps of granular matters are formed so as to have high strength in a short amount of time, the clumps do not easily disintegrate and are easy to handle even when moved immediately after clump formation and discarded.

In a preferable aspect of the present embodiment, the powder content of the animal litter is 0.50% by mass or less. As such, in the present animal litter, the powder content is 0.50% by mass or less. Therefore, powder generation of the animal litter is small, powder is less likely to scatter in a litter box or around the litter box, facilitating cleaning of the litter box and the surroundings of the litter box. In addition. since powder generation is small, the likelihood of damaging electronic devices such as automatic litter boxes can be decreased.

### Measurement Method for Powder Content of Animal Litter

The powder content of the animal litter is measured by the following method.

For the powder content of the animal litter. a test sieve is vibrated by hand or with a vibratory sieve machine, allowing powder and dust of 250 μm or less to pass through the sieve mesh openings, and after sieving is complete, the weight of the sample remaining on the sieve is weighed out, and the powder content of the cat litter sample is calculated.

### (1) Apparatus

60-mesh test sieve (250 μm) conforming to standards
Electronic balance (0.02 g)
Vibratory sieve machine (frequency of 100 to 300 times/min, amplitude of 1 mm to 4 mm)

### (2) Reagent

500 g of measurement sample

### (3) Procedure

(i) 500 g of the sample is placed on the 60-mesh test sieve, and the sieve lid is closed.
(ii) Measurement
   (ii-1) Hand screening method

The test sieve is vibrated by hand at an amplitude of about 0. 1 m, at a frequency of about 120 times/minute, and for a sieving time of 5 hours. After leaving to stand for 3 minutes, the weight of the sample remaining on the sieve is weighed and taken as M, and calculations are carried out according to the calculation formula below.
(ii-2) Shaker method

The test sieve on which the sample is placed is fixed to a vibratory sieve machine, and the amplitude is set to 1 mm, frequency to 120 times/minute. and sieving time to 5 minutes. After leaving to stand for 3 minutes. the weight of the sample remaining on the sieve is weighed out and taken as M, and calculations are carried out according to the calculation formula below.
(iii) Calculation formula

$$Powder content = \{ ( 500 - M ) / 500 \} \times 100$$

Powder content of 0.5% by mass or less is considered passing (OK), and anything else is considered failing (NG).

The animal litter of the present embodiment can be suitably used in general animal litter boxes and automatic animal litter boxes for animals. However, the animal litter of the present embodiment is not limited thereto and, for example, can be applied as a bedding material for breeding cages and livestock sheds. Further, the present animal litter is not limited to the above embodiment or the following Examples, and appropriate modifications or combinations can be made within a scope that does not deviate from the object or spirit of the present invention.

### EXAMPLES

Hereinafter, the present invention will be further specifically described with reference to the Examples and Comparative Examples. However, the present invention is not limited to these Examples.

### (1) Sample

The samples of the Examples and Comparative Examples are as follows.
(a) Granular matters of Examples 1 and 2

Sodium carbonate and water were added to pulverized raw bentonite ore and mixed. After mixing, the mixture was dried in a dryer to obtain granular matters. The obtained granular matters were classified using a vibratory sieve machine to obtain granular matters of Examples 1 and 2.
(b) Granular matters of Comparative Examples 1 to 3

The granular matters (animal litter) of Comparative Examples 1 to 3 are commercially available products. Specifically, the product of Comparative Example 1 was “Blue Label” manufactured by ARM & HAMMER, the product of Comparative Example 2 was a deodorizing natural raw ore litter manufactured by NetEase. Inc., and the product of Comparative Example 3 was DeoSand post-urination scented litter (natural green scent) manufactured by Unicharm Corporation.

### (2) Evaluation

The samples of Examples 1 and 2 and Comparative Examples 1 to 3 were evaluated for the following characteristics.
Granular matters: grain size distribution, bulk density, powder content, cation-exchange capacity, pH. degree of swelling, and moisture content.
Clump: strength, volume, thickness (depth), short-side length, long-side length, mass, and ratio of clump strength of granular matters after 1 minute has elapsed since the addition of a saline solution relative to clump strength of granular matters after 5 minutes have elapsed since the addition (strength (after 1 minute)/strength (after 5 minutes) (%)).

The measurement methods of these characteristics are as described above.

The results are shown in the following Table 1 to Table 3. In each table, Ex. 1 and Ex. 2 indicate Example 1 and Example 2, respectively, and Comp. Ex. 1. Comp. Ex. 2, and Comp. Ex. 3 indicate Comparative Example 1, Comparative Example 2, and Comparative Example 3, respectively. Table 1 shows the grain size distribution, which indicates mass percentage (%) of the granular matters in each grain size, and bulk density and powder content of the granular matters. Regarding grain size distribution, the grain size distribution of Comparative Example 3 was described based on values on the product packaging, which were 70.0% by mass or more for 2 mm or more, 25.0% by mass or less for 1 to 2 mm, 3.0% by mass or less for 0.15 to 1 mm, and 0.15% by mass or less for 0.15 mm or less. Table 2 shows characteristics of the granular matters. The columns “1 min.” and “5 min.” show the characteristics of clumps of granular matters after 1 minute and 5 minutes, respectively, has elapsed since the addition of 20 ml of a 0.9% by mass saline solution to the granular matters Table 3 shows cation-exchange capacity, pH, degree of swelling, moisture content of the granular matters (essentially the cation-exchange capacity, pH, degree of swelling, and moisture content of bentonite). In addition, the ratio of strength after 1 minute has elapsed since the addition of 20 ml of a 0.9% by mass saline solution to the granular matters relative to strength after 5 minutes have elapsed since the addition is further shown.

TABLE 1

| | Grain size distribution (% by mass) | | | | | | Bulk | Powder content |
|---|---|---|---|---|---|---|---|---|
| | <0.3 | 0.3 to | 0.5 to | 1.0 to | 1.5 to | 2.0 to | density | (≤0.5% by |
| Sample | (mm) | 0.5 (mm) | 1.0 (mm) | 1.5 (mm) | 2.0 (mm) | 2.5 (mm) | (g/ml) | mass) |
| Ex. 1 | 0.06 | 3.26 | 37.28 | 47.64 | 8.24 | 3.12 | 1.01 | OK |
| Ex. 2 | 0.05 | 0.83 | 41.60 | 47.78 | 8.52 | 1.02 | 1.03 | OK |
| Comp. Ex. 1 | 3.28 | 30.08 | 61.00 | 3.22 | 1.60 | 0.08 | 1.20 | OK |
| Comp. Ex. 2 | 0.20 | 0.48 | 40.30 | 48.92 | 9.94 | 0.10 | 1.02 | OK |

| | | | | | |
|---|---|---|---|---|---|
| Comp. Ex. 3 | ≤3.15 | ≤25.0 | 70.0≤* | 1.03 | NG |

*Indicates value in grain size of “2.0 mm or more.”

TABLE 2

| | Clump | | | | | | | | | | | |
|---|---|---|---|---|---|---|---|---|---|---|---|---|
| | 1 min. | | | | | | 5 min. | | | | | |
| | Mass | Long side | Short side | Depth | Volume | Strength | Mass | Long side | Short side | Depth | Volume | Strength |
| Sample | (g) | (mm) | (mm) | (mm) | (ml) | (N) | (g) | (mm) | (mm) | (mm) | (ml) | (N) |
| Ex. 1 | 62.0 | 52.6 | 50.6 | 35.2 | 41.8 | 10.5 | 63.3 | 55.3 | 51.5 | 35.6 | 43.1 | 13.0 |
| Ex. 2 | 62.1 | 52.9 | 48.5 | 33.2 | 40.9 | 10.9 | 59.2 | 58.6 | 54.6 | 32.5 | 38.1 | 12.2 |
| Comp. Ex. 1 | 74.9 | 63.8 | 54.0 | 29.4 | 45.8 | 3.56 | 77.8 | 75.2 | 54.7 | 29.5 | 48.2 | 3.51 |
| Comp. Ex. 2 | 71.1 | 54.7 | 51.7 | 35.4 | 50.3 | 4.84 | 70.9 | 56.4 | 52.7 | 35.7 | 50.1 | 5.93 |
| Comp. Ex. 3 | 103 | 50.4 | 40.2 | 107 | 80.8 | 8.9 | 101 | 44.8 | 35.6 | 109 | 78.4 | 10.9 |

TABLE 3

| | Cation- | | | Moisture | Strength (after |
|---|---|---|---|---|---|
| | exchange | | Degree | content | 1 minute)/ |
| | capacity | | of | (% | strength (after |
| | (meq/100 g) | pH | swelling | by mass) | 5 minute) (%) |
| Ex. 1 | 78.9 | 10.47 | 18.0 | 7.13 | 80.8 |
| Ex. 2 | 77.7 | 10.45 | 19.0 | 5.74 | 89.3 |
| Comp. Ex. 1 | 35.8 | 8.96 | 14.0 | 4.27 | 101.4 |
| Comp. Ex. 2 | 65.8 | 8.82 | 15.5 | 9.63 | 81.2 |
| Comp. Ex. 3 | 49.2 | 9.02 | 15.0 | 2.11 | 81.2 |

The samples of Examples 1 and 2 satisfied the condition of 80% by mass or more (84.92% by mass and 89.38% by mass) of granular matters having a grain size of 0.5 mm or more and 1.5 mm or less. Further, the samples of Examples 1 and 2 satisfied the condition that the clump strength of a clump of granular matters after 1 minute has elapsed since the addition of 20 ml of a 0.9% by mass saline solution to the animal litter is 8.0 N or more (10.5 N and 10.9 N). Among Comparative Examples 1 to 3, the sample of Comparative Example 1 did not satisfy the above conditions of grain size and strength, the sample of Comparative Example 2 did not satisfy the above condition of strength, and the sample of Comparative Example 3 did not satisfy the above condition of grain size.

The samples of Examples 1 and 2 satisfied the condition that the thickness (depth) of a clump of granular matters when 20 ml of a 0.9% by mass saline solution is added to the animal litter is 40 mm or less (35.6 mm and 32.5 mm: 5 min.). Further. the samples of Examples 1 and 2 satisfied the condition that the volume of a clump of granular matters after 1 minute has elapsed since the addition of 20 ml of a 0.9% by mass saline solution to the animal litter is 20 ml/20 ml to 50 ml/20 ml (41.8 ml/20 ml and 40.9 ml/20 ml). Among Comparative Examples 1 to 3, the sample of Comparative Example 1 satisfied the above conditions of thickness (depth) and volume, the sample of Comparative Example 2 did not satisfy the above condition of volume, and the sample of Comparative Example 3 did not satisfy the above condition of thickness (depth) and volume.

In the samples of Examples 1 and 2, the condition that the cation-exchange capacity of bentonite in the granular matters is 70 meq/100 g or more was satisfied (78.9 meq/100 g and 77.7 meq/100 g). Further. the samples of Examples 1 and 2 satisfied the condition that the pH of the bentonite in the granular matters is 9 to 11 (10.47 and 10.45). Moreover, the sample of Examples 1 and 2 satisfied the condition that the degree of swelling of the granular matters is 16 or greater (18.0 and 19.0). Among Comparative Examples 1 to 3. the sample of Comparative Example 1 did not satisfy the above conditions of cation-exchange capacity, pH, and degree of swelling; the sample of Comparative Example 2 did not satisfy the conditions of cation-exchange capacity, pH, and degree of swelling; and the sample of Comparative Example 3 did not satisfy the conditions of cation-exchange capacity, and degree of swelling.

The samples of Examples 1 and 2 satisfied the condition that the clump strength of a clump of granular matters after 5 minutes have elapsed since the addition of 20 ml of saline solution is identical to or greater than the clump strength of the clump of granular matters after 1 minute has elapsed since the addition. Further, the samples of Examples 1 and 2 satisfied the condition that the clump strength of a clump of the granular matters after 1 minute has elapsed since the addition of 20 ml of a 0.9% by mass saline solution is 80% or more of the clump strength of the clump of the granular matters after 5 minutes have elapsed since the addition (80.8% and 89.3%). Among Comparative Examples 1 to 3, the samples of Comparative Examples 2 and 3 satisfied the above two conditions. but the sample of Comparative Example I did not satisfy the above two conditions.

1. Animal litter comprising granular matters mainly composed of bentonite,
wherein the granular matters comprise 80% by mass or more of granular matters having a grain size of 0.5 mm or more and 1.5 mm or less, and
wherein clump strength of a clump of the granular matters after 1 minute has elapsed since addition of 20 ml of a 0.9% by mass saline solution to the animal litter is 8.0 N or more.

2. The animal litter according to claim 1,
wherein the animal litter is used in an automatic litter box for cats.

3. The animal litter according to claim 1,
wherein a thickness of a clump of the granular matters when 20 ml of a 0.9% by mass saline solution is added to the animal litter is 40 mm or less.

4. The animal litter according to claim 1,
wherein volume of a clump of the granular matters after 1 minute has elapsed since addition of 20 ml of a 0.9% by mass saline solution to the animal litter is 20 ml/20 ml to 50 ml/20 ml.

5. The animal litter according to claim 1,
wherein cation-exchange capacity of the bentonite in the granular matters is 70 meq/100 g or more.

6. The animal litter according to claim 1,
wherein pH of the bentonite in the granular matters is 9 to 11.

7. The animal litter according to claim 1,
wherein a degree of swelling of the granular matters is 16 or greater.

8. The animal litter according to claim 1,
further comprising a fragrance,
wherein at least a portion of the fragrance is incorporated into an inner portion of each of the granular matters.

9. The animal litter according to claim 1,
further comprising an antibacterial agent.

10. The animal litter according to claim 1,
Wherein clump strength of a clump of the granular matters after 5 minutes have elapsed since addition of 20 ml of a 0.9% by mass saline solution to the animal litter is identical to or greater than the clump strength of the clump of the granular matters after 1 minute has elapsed since the addition.

11. The animal litter according to claim 1,
wherein the clump strength of the clump of the granular matters after 1 minute has elapsed since addition of 20 ml of a 0.9% by mass saline solution to the animal litter is 80% or more of clump strength of the clump of the granular matters after 5 minutes have elapsed since the addition.

12. The animal litter according to claim,
wherein powder content of the animal litter is 0.50% by mass or less.
